(19) United States
(12) Patent Application Publication
(10) Pub. No.: US 2019/0004622 A1
(43) Pub. Date: Jan. 3, 2019

(54) Systems, Methods, and Devices for Providing a Virtual Reality Whiteboard

(71) Applicant: Walmart Apollo, LLC, Bentonville, AR (US)

(72) Inventors: John Jeremiah O'Brien, Farmington, AR (US); Steven Lewis, Bentonville, AR (US); John Paul Thompson, Bentonville, AR (US)

(21) Appl. No.: 16/008,641

(22) Filed: Jun. 14, 2018

Related U.S. Application Data
(60) Provisional application No. 62/525,875, filed on Jun. 28, 2017.

(51) Int. Cl. G06F 3/0354; G06F 3/0488; G06T 19/00; G02B 27/01

(52) U.S. Cl. CPC G06F 3/03545; G02B 27/0172; G06T 19/006; G06F 3/04883

(57) ABSTRACT

Methodologies, systems, and computer-readable media are provided for generating an interactive virtual whiteboard. A number of motion sensors are arranged to scan a planar surface, and an electronic stylus in communication with the motion sensors estimates the location of the electronic stylus on the planar surface with respect to the motion sensors. The electronic stylus also detects an orientation or acceleration of the stylus using an inertial sensor. Based on location data and orientation data from the stylus, a computing system generates a visual representation of the motion of the electronic stylus with respect to the planar surface.

### RELATED APPLICATIONS

This application claims priority to U.S. Provisional Patent Application No. 62/525,875 entitled “SYSTEMS, METHODS, AND DEVICES FOR PROVIDING A VIRTUAL REALITY WHITEBOARD,” filed on Jun. 28, 2017, the content of which is hereby incorporated by reference in its entirety.

### BACKGROUND

Various types of whiteboards and working surfaces are conventionally used for writing and drawing in the workplace or academic settings. In order to work on or view the same whiteboard, individuals must typically be physically present in the same location.

### SUMMARY

Embodiments of the present disclosure utilize sensors and an electronic stylus to generate a virtual whiteboard environment. In one embodiment, an interactive virtual whiteboard system includes motion sensors arranged to scan a planar surface, and an electronic stylus in communication with the motion sensors over a first communication channel. The electronic stylus includes a writing tip that may be controlled by a user to engage the planar surface. The electronic stylus also includes a stylus location sensor and an inertial sensor. The stylus location sensor is configured to estimate the location of the electronic stylus on the planar surface with respect to the motion sensors and generate location data, while the inertial sensor is configured to detect an orientation or acceleration of the electronic stylus and generate orientation data.

Embodiments of the system also include a computing system in communication with the electronic stylus and the motion sensors over a second communication channel. The computing system is programmed to execute a virtual whiteboard module to receive a stream of the location data and the orientation data from the electronic stylus indicating a location and orientation of the electronic stylus with respect to the motion sensors as a function of time. The virtual whiteboard module also generates a visual representation of a motion of the electronic stylus with respect to the planar surface based on the stream of location data and orientation data received from the electronic stylus.

Additional combinations and/or permutations of the above examples are envisioned as being within the scope of the present disclosure. It should be appreciated that all combinations of the foregoing concepts and additional concepts discussed in greater detail below (provided such concepts are not mutually inconsistent) are contemplated as being part of the inventive subject matter disclosed herein. In particular, all combinations of claimed subject matter appearing at the end of this disclosure are contemplated as being part of the inventive subject matter disclosed herein.

### BRIEF DESCRIPTION OF THE DRAWINGS

The skilled artisan will understand that the drawings are primarily for illustrative purposes and are not intended to limit the scope of the inventive subject matter described herein. The drawings are not necessarily to scale; in some instances, various aspects of the inventive subject matter disclosed herein may be shown exaggerated or enlarged in the drawings to facilitate an understanding of different features. In the drawings, like reference characters generally refer to like features (e.g., functionally similar and/or structurally similar elements).

The foregoing and other features and advantages provided by the present invention will be more fully understood from the following description of exemplary embodiments when read together with the accompanying drawings, in which:

FIG. 1 is a flowchart illustrating an exemplary method for generating an interactive virtual whiteboard, according to an exemplary embodiment.

FIG. 2 is a flowchart illustrating another exemplary method for generating an interactive virtual whiteboard, according to an exemplary embodiment.

FIG. 3A shows an electronic stylus configured to interact with a virtual whiteboard, according to an exemplary embodiment.

FIG. 3B is a block diagram of electronic stylus circuitry that can be disposed within the electronic stylus of FIG. 3A, according to an exemplary embodiment.

FIG. 4 is a block diagram of motion sensor circuitry that can be disposed within a motion sensor, according to an exemplary embodiment.

FIG. 5A illustrates an example virtual whiteboard, according to an exemplary embodiment.

FIG. 5B illustrates another example virtual whiteboard with a projected image, according to an exemplary embodiment.

FIG. 6 illustrates another example virtual whiteboard, according to an exemplary embodiment.

FIG. 7 illustrates a relationship between a virtual whiteboard and a real-world whiteboard, according to an exemplary embodiment.

FIG. 8 shows another example virtual whiteboard, according to an exemplary embodiment.

FIG. 9 is a diagram of an exemplary network environment suitable for a distributed implementation of an exemplary embodiment.

FIG. 10 is a block diagram of an exemplary computing device that can be used to perform exemplary processes in accordance with an exemplary embodiment.

### DETAILED DESCRIPTION

Following below are more detailed descriptions of various concepts related to, and embodiments of, inventive methods, apparatus, and systems for generating an interactive virtual whiteboard. It should be appreciated that various concepts introduced above and discussed in greater detail below may be implemented in any of numerous ways, as the disclosed concepts are not limited to any particular manner of implementation. Examples of specific implementations and applications are provided primarily for illustrative purposes.

As used herein, the term “includes” means “includes but is not limited to,” the term “including” means “including but not limited to.” The term “based on” means “based at least in part on.”

Conventional whiteboards are often used by hobbyists, inventors, business professionals, students, academics, etc. These conventional whiteboards allow users to draw and write ideas on a large space and work together, as long as the users are within the same vicinity and are able to work on the same whiteboard. However, colleagues or associates at different locations are not able to work on the same board together, and whiteboard surfaces can be costly and occupy large surfaces.

The present disclosure describes systems, devices, and methods for generating a virtual whiteboard that allows individuals to interact with the same virtual whiteboard while at different locations. A number of individuals can interact, edit, draw, and design with others who are immersed in a virtual whiteboard environment. In exemplary embodiments, motion sensors may be positioned or mounted on a wall or desk surface in order to create a whiteboard space out of any surface at any location. Users will not necessarily be limited by the dimensions of a physical whiteboard, and they may be able to collaborate on a virtual whiteboard at any location or time. In some embodiments, the sensors can interact with a smart electronic stylus in order to track the movements of the electronic stylus. The electronic stylus and sensors may be charged from kinetic energy, in some embodiments, in order to improve mobility of the virtual whiteboard. The sensors may include, for example, one or more cameras and an infrared light source. In one example embodiment, the sensors may be placed on a picnic table surface, which may act as a virtual whiteboard surface, and an electronic stylus may be used to virtually collaborate with another individual at a remote location. In some embodiments, a tablet, portable smart device, or visual display headset may be used to view the content of the virtual whiteboard surface.

In exemplary embodiments, a 3-D body scanner or virtual reality headset may be used to immerse a user in a virtual whiteboard environment and generate an image of their person in the virtual environment. In some embodiments, the planar surface with which the user may interact may be a prefabricated surface designed to capture the whiteboard environment, or a regular surface or open space that has been scanned or captured by motion sensors. A number of sensors can communicate with each other, in some embodiments, in order to provide a field-of-capture for the virtual whiteboard space, which may allow any space to be used as a virtual whiteboard space. In some embodiments, one user may limit access to some or all of the content of the virtual whiteboard environment to particular users for particular times.

In exemplary embodiments, various function buttons of the electronic stylus may allow a user to save screenshots, bring elements to the foreground or background, change stylus colors or textures, etc. The computing system or electronic stylus may also implement handwriting recognition and translation features, in some embodiments. In one example embodiment, a user can calibrate the electronic stylus using the location sensors and inertial sensors within the electronic stylus in order to initially define a virtual whiteboard space. For example, the electronic stylus itself may track its location without external sensors, allowing a user to initially draw out or delineate a virtual whiteboard surface.

Exemplary embodiments are described below with reference to the drawings. One of ordinary skill in the art will recognize that exemplary embodiments are not limited to the illustrative embodiments, and that components of exemplary systems, devices and methods are not limited to the illustrative embodiments described below.

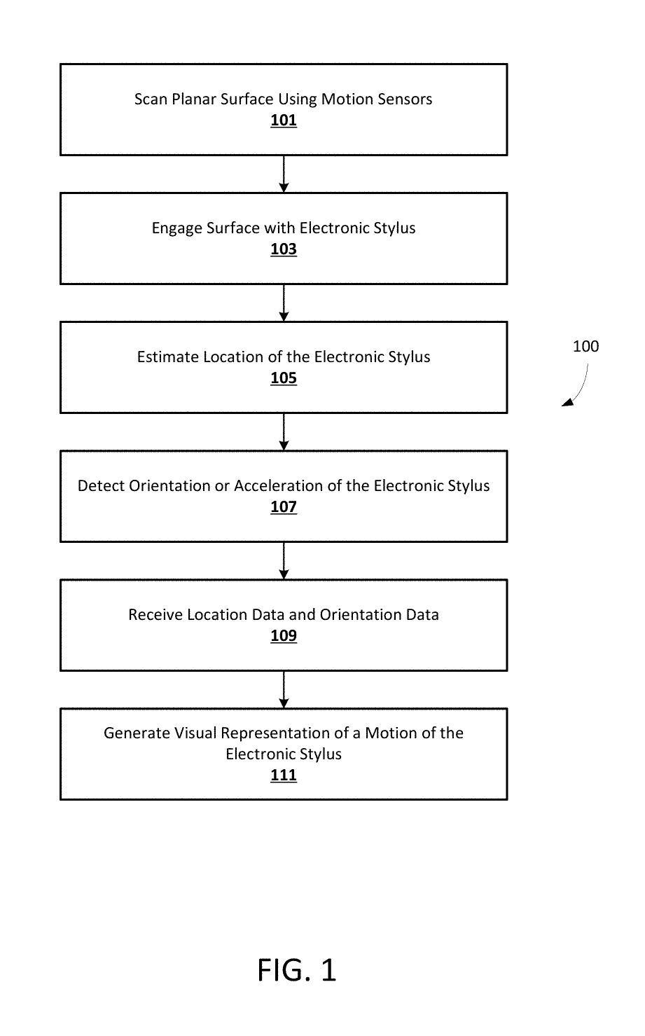

FIG. 1 is a flowchart illustrating an exemplary method 100 for generating an interactive virtual whiteboard, according to an exemplary embodiment. It will be appreciated that the method is programmatically performed, at least in part, by one or more computer-executable processes executing on, or in communication with one or more servers described further below. In step 101, a planar surface is scanned using a number of motion sensors. In exemplary embodiments, the motion sensors can scan a physical whiteboard space, a desk surface, a window or glass surface, a wall, or any suitable surface. In some embodiments, the motion sensors may communicate with various smart devices and may include one or more microphones or speakers for audio capture and output. The size of the planar surface scanned, and therefore the size of the virtual whiteboard, may be determined by the user based on the placement of the motion sensors, in some embodiments. The motion sensors can be positioned using, for example, adhesives, Velcro®, suction cups, magnets, etc.

In step 103, a writing tip of an electronic stylus engages with the planar surface. The electronic stylus is configured to be controlled by a user and can include, in some embodiments, sensors and electronic circuitry configured to control various aspects of the system described herein. For example, the stylus can include a stylus location sensor, an inertial sensor, a pressure/force sensor, an on/off switch, a camera, a microphone, a speaker, etc. The writing tip can also include an ink dispensing structure such that the writing tip deposits ink on the planar surface when the writing tip of the electronic stylus engages the planar surface.

In step 105, a stylus location sensor included within the electronic stylus estimates a location of the writing tip of the electronic stylus on the planar surface with respect to the motion sensors. In some embodiments, the stylus location sensor can include an RF transceiver that is configured to determine a location based on power of received signals from the motion sensors. For example, an RF transceiver can receive signals from the motion sensors at a given power, and a processing device associated with the electronic stylus can generate a position based on the power at which various signals are received. An accelerometer can be used in conjunction with an RF transceiver, in some embodiments, to determine the electronic stylus' relative location. The stylus location sensor generates location data that can capture the movements of the writing tip of the electronic stylus on the planar surface. In some embodiments, the stylus location sensor is in wireless communication with one or more of the motion sensors and can dynamically calculate the location of the electronic stylus within the planar surface and with respect to the motion sensors.

In step 107, an inertial sensor included within the electronic stylus detects an orientation or acceleration of the electronic stylus. The inertial sensor generates orientation data that can capture the orientation and acceleration of the stylus. In some embodiments, the inertial sensor can include one or more of a gyroscope, accelerometer, piezoelectric accelerometer, strain gauge, or any other sensor suitable for detecting the orientation or acceleration of the electronic stylus.

In step 109, a computing system in communication with the electronic stylus and the motion sensors executes a virtual whiteboard module to receive a stream of the location data and the orientation data from the electronic stylus. The location data and orientation data indicates to the computing system the location and orientation of the stylus with respect to the motion sensors as a function of time. This data can indicate the movements, orientation, and acceleration of the electronic stylus at or near the planar surface. In some embodiments, the electronic stylus includes various control features or functionality buttons that can determine when the electronic stylus generates the location data and orientation data described above and transmits that data to the computing system. For example, a user can activate a switch or button of the electronic stylus when the user wishes to use the stylus in order to begin generating location data and orientation data. Before the switch or button is activated, the electronic stylus can be in a low power mode or off mode, such that the motion of the electronic stylus is not tracked and data is not transmitted to the computing system.

In step 111, the virtual whiteboard module generates a visual representation of the motion of the electronic stylus with respect to the planar surface based on the stream of location data and orientation data received from the electronic stylus at the computing system. As described herein, in some embodiments, the electronic stylus may include a marker tip for writing on a whiteboard surface and the whiteboard surface may correspond to the scanned planar surface. The pressure or force sensor can be used to detect when the writing tip is engaged with the planar surface to determine when the electronic stylus is being used to write on the planar surface. In such an example, the visual representation generated by the virtual whiteboard module may be substantially similar to images drawn by the electronic stylus on a real-world whiteboard. This visual representation can be displayed to the user, or any other individual, using a computer screen, projector, or any other suitable visual display device.

In exemplary embodiments, the virtual whiteboard system described herein can include a second electronic stylus that can communicate with and interact with the motion sensors in the same or similar way as the electronic stylus described above. In such embodiments, the second electronic stylus can generate location data and orientation data, as described above in reference to steps 105 and 107, and the virtual whiteboard module can receive this data and generate a second visual representation as described in steps 109 and 111. In some embodiments, the visual representations may need to be modified or adjusted in scale in order to make visual content from multiple input sources, such as multiple electronic styluses, appear properly for each user.

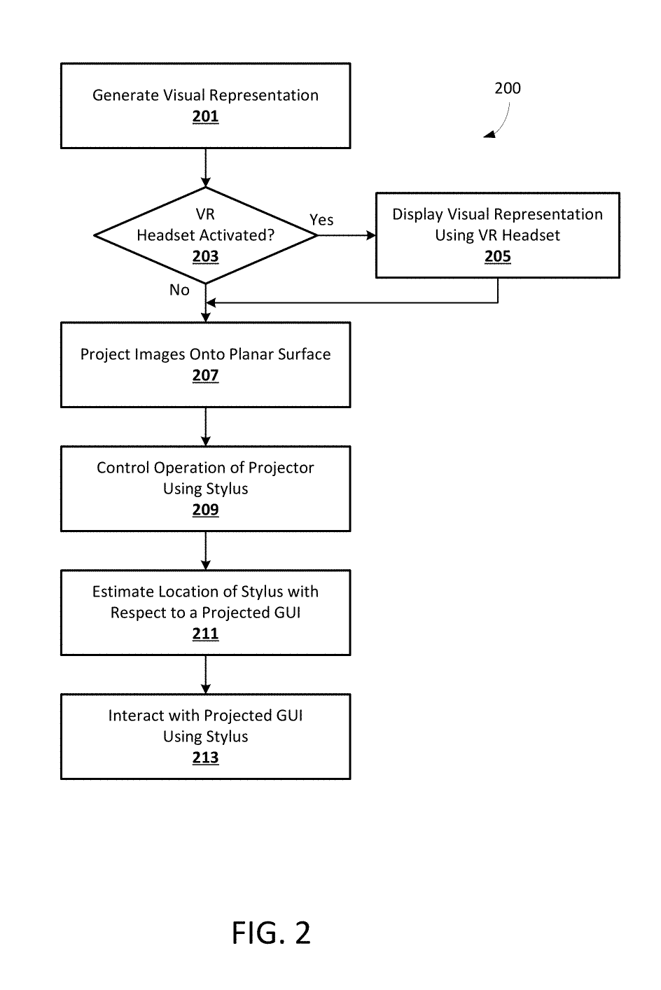

FIG. 2 is a flowchart illustrating another exemplary method 200 for generating an interactive virtual whiteboard, according to an exemplary embodiment. It will be appreciated that the method is programmatically performed, at least in part, by one or more computer-executable processes executing on, or in communication with one or more servers described further below. In step 201, a virtual whiteboard module executed by a computing system generates a visual representation of a motion of an electronic stylus with respect to a scanned planar surface, as described above in reference to FIG. 1.

In step 203, the method determines whether a virtual reality headset is activated and in communication with the computing system. If a virtual reality headset is activated and in communication with the computing system, the method continues in step 205 with displaying the visual representation of the motion of the electronic stylus with respect to the planar surface using the virtual reality headset. In some embodiments, the virtual reality headset can be an augmented reality headset that can combine certain aspects of a real-world environment with visual and/or audio input. In such embodiments, the visual representation of the motion of the electronic stylus can be displayed using augmented reality techniques. In some embodiments, the user of the electronic stylus can be working on a virtual whiteboard using the scanned planar surface, as described above, and a different user can view the virtual whiteboard at a remote location using the virtual reality headset.

Once the visual representation is displayed in step 205, or if it is determined in step 203 that no virtual reality headset is activated, the method continues in step 207 with projecting images onto the planar surface using a projector in communication with the computing system. In some embodiments, the images can include the visual representations generated in step 201, a slideshow or presentation, or any other images a user or users wish to project onto the planar surface.

In step 209, the electronic stylus is used to control an operation of the projector. In some embodiments, the electronic stylus is in communication with the computing system and may be used to turn the projector on or off, navigate slides projected onto the planar surface, activate or deactivate audio associated with the projection, determine which images are projected onto the planar surface, or control other operations of the projector.

In step 211, a location sensor associated with the electronic stylus can estimate the location of the electronic stylus with respect to a graphical user interface projected from the projector. As discussed above, the electronic stylus can include, in some embodiments, a stylus location sensor, an inertial sensor, an on/off switch, a camera, a microphone, a speaker, etc. Because the computing system may be configured to project images, including a graphical user interface, onto the scanned planar surface, and the computing system may compute the location of the electronic stylus with respect to the planar surface, the computing system can also estimate the location of the electronic stylus with respect to images projected onto the planar surface, including a graphical user interface, in some embodiments.

In step 213, the user of the electronic stylus can interact with the graphical user interface projected onto the planar surface using the electronic stylus. In some embodiments, various control features or buttons of the electronic stylus, along with gestures performed by the electronic stylus on or near the planar surface, can be used to interact with the graphical user interface projected onto the planar surface.

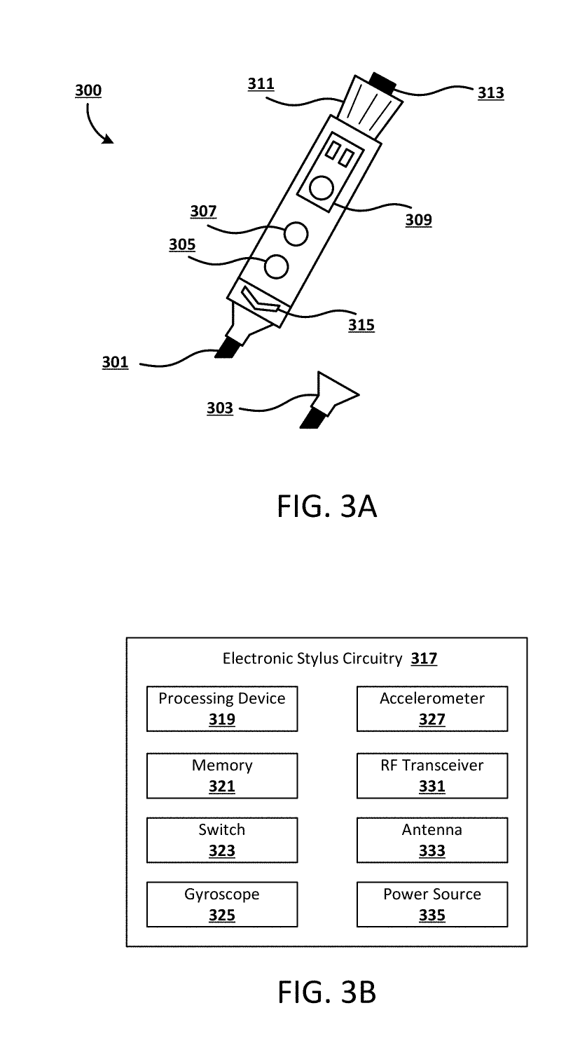

FIG. 3A shows an electronic stylus 300 with a replaceable writing tip, according to an exemplary embodiment. In this example embodiment, the electronic stylus 300 includes a writing tip 301 and a replacement writing tip 303 that may be removably attached to the electronic stylus 300. The writing tip 301 can be a refillable felt marker tip, in some embodiments. The writing tip 301 may also include a sensor (e.g., a pressure or force sensor) configured to detect when the tip 301 has been applied to a surface. Such a sensor may facilitate capturing movements of the electronic stylus, and data from such a sensor may be transferred to a computing system, as described above in reference to the location data and orientation data of FIG. 1. For example, when the sensor detects that the writing tip is engaged with a surface (e.g., the sensor detects a force being applied to the writing tip) and a location sensor (such as an RF transceiver and/or accelerometer) determines that the electronic stylus is within the area defined by the motion sensors corresponding to the virtual white board, the electronic stylus can translate movements of the electronic stylus into writing on the virtual whiteboard, and when the sensor detects that the writing tip is not engaged with a surface (e.g., no force is being applied to the writing tip) and the location sensor determines that the electronic stylus is within the area defined by the motion sensors corresponding to the virtual white board, the electronic stylus can cease translating movements of the stylus into writing on the virtual whiteboard. In exemplary embodiments, the electronic stylus 300 may include various control features or buttons 305, 307 that may be configured to erase virtual images generated by the stylus, control a function of the electronic stylus 300, control a function of a projector, import or export images or data, etc. The electronic stylus 300 may also include an LED or visual display 309 that may display images, graphics, a GUI, or indicate a mode of active function of the electronic stylus 300. In some embodiments, the control features 305, 307 and visual display 309 may be used to draw specific shapes, select colors, textures, or designs, and convert words or writing into text format. The electronic stylus 300 may also include a cap 311 and an on/off button 313, in some embodiments. The visual display 309 may be implemented with touchscreen functionality, in some embodiments, and may be used to indicate battery life, connectivity status, microphone status, etc.

In exemplary embodiments, the electronic stylus 300 may include a microphone, speaker, a kinetic energy charging system (e.g., a battery, capacitor, coil, and magnet), a charging port, a data port, etc. In some embodiments, the electronic stylus 300 includes a function switch 315 that can enable a purely virtual operating mode of the electronic stylus, in which the writing tip 301 does not write in the real-world environment, while the motion of the electronic stylus is still captured and a visual representation of the movements of the stylus can still be electronically generated.

FIG. 3B is a block diagram of electronic stylus circuitry 317 that can be disposed within the electronic stylus 300 shown in FIG. 3A. The electronic stylus circuitry 317 can include, for example, a multi-axis accelerometer 327, a radio frequency (RF) transceiver 331, a processing device 319, memory 321 (e.g., RAM), a power source 335, and a switch 323. In some embodiments, the electronic stylus circuitry 317 can include a gyroscope 325 in addition to, or in the alternative to, the multi-axis accelerometer 327.

The multi-axis accelerometer 327 can include three or more axes of measurement and can output one or more signals corresponding to each axes of measurement and/or can output one or more signals corresponding to an aggregate or combination of the three axes of measurement. For example, in some embodiments, the accelerometer 327 can be a three-axis or three-dimensional accelerometer that includes three outputs (e.g., the accelerometer can output X, Y, and Z data). The accelerometer 327 can detect and monitor a magnitude and direction of acceleration, e.g., as a vector quantity, and/or can sense an orientation, vibration, and/or shock. For example, the accelerometer 327 can be used to determine an orientation and/or acceleration of the electronic stylus 300. In some embodiments, the gyroscope 325 can be used instead of or in addition to the accelerometer 327, to determine an orientation of the electronic stylus 300. The orientation of the stylus can be used to determine when the user is performing a gesture and/or to identify and discriminate between different gestures made with the electronic stylus. The acceleration and/or velocity can also be used to identify and discriminate between different gestures performed by the electronic stylus. For example, when making a square-shaped gesture the acceleration decreases to zero when the electronic stylus changes direction at each corner of the gesture.

The processing device 319 of the electronic stylus circuitry 317 can receive one or more output signals (e.g., X, Y, Z data) from the accelerometer 327 (or gryroscope 325) as inputs and can process the signals to determine a movement and/or relative location of the electronic stylus 317. The processing device 319 may be programmed and/or configured to process the output signals of the accelerometer 327 (or gyroscope 325) to determine when to change a mode of operation of the electronic stylus circuitry 317 (e.g., from a sleep mode to an awake mode).

The RF transceiver 331 can be configured to transmit (e.g., via a transmitter of the RF transceiver) and/or receive (e.g., via a receiver of the RF transceiver) wireless transmissions via an antenna 333. For example, the RF transceiver 331 can be configured to transmit one or more messages, directly or indirectly, to one or more electronic devices or sensors, and/or to receive one or more messages, directly or indirectly, from one or more electronic devices or sensors. The RF transceiver 331 can be configured to transmit and/or receive messages having a specified frequency and/or according to a specified sequence and/or packet arrangement. As one example, the RF transceiver 331 can be a BlueTooth® transceiver configured to conform to a BlueTooth® wireless standard for transmitting and/or receiving short-wavelength radio transmissions typically in the frequency range of approximately 2.4 gigahertz (GHz) to approximately 2.48 GHz. As another example, the RF transceiver 331 can be a Wi-Fi transceiver (e.g., as defined IEEE 802.11 standards), which may operate in an identical or similar frequency range as BlueTooth®, but with higher power transmissions. Some other types of RF transceivers 331 that can be implemented by the sensor module circuitry include RF transceivers configured to transmit and/or receive transmissions according to the Zigbee® communication protocol, and/or any other suitable communication protocol. The memory 321 can include any suitable non-transitory computer-readable storage medium (e.g., random access memory (RAM), such as, e.g., static RAM (SRAM), dynamic RAM (DRAM), and the like).

In exemplary embodiments, the processing device 319 can be programmed to receive and process information/data from the accelerometer 327 (e.g. X, Y, Z data), RF transceiver 331, memory 321, and/or can be programmed to output information/data to the RF transceiver 331, and/or the memory 321. As one example, the processing device 319 can receive information/data from the accelerometer 327 corresponding to a direction force along one or more of the axes of the accelerometer 327, and can transmit the information data to a computing system via the RF transceiver 331. As another example, the processing device 319 can receive information/data from the accelerometer 327 corresponding to a direction force along one or more of the axes of the accelerometer 327, can process the information/data to generate an indicator associated with an impact between the electronic stylus 300 and a planar surface or associated with a gesture of the electronic stylus, and can transmit the indicator to a computing system via the RF transceiver 331.

The power source 335 can be implemented as a battery or capacitive elements configured to store an electric charge. In some embodiments, the battery may be replaceable by the user. As another example, in some embodiments, the power source 335 can be a rechargeable power source, such as a battery or one or more capacitive elements configured to be recharged via a connection to an external power supply and/or to be recharged by an energy harvesting device. As one example, the rechargeable power source can be recharged using solar energy (e.g., by incorporating photovoltaic or solar cells on the housing on the sensor module), through physical movement (e.g., by incorporating a piezo-electric elements in the sensor module), and/or through any other suitable energy harvesting techniques using any suitable energy harvesting devices.

The switch 323 can be operatively coupled to the processing device 319 to trigger one or more operations by the processing device 319. In some embodiments, the switch 323 can be implemented as a momentary push button, rocker, and/or toggle switch that can be activated by a user. For example, in exemplary embodiments, the switch 323 can be activated by the user to instruct the processing device 319 to transmit an association or initial setup message via the RF transceiver 331. The association or initial setup message can be used to pair the sensor module with an electronic device. In some embodiments, the association or initial setup message can be transmitted according to a BlueTooth® pairing scheme or protocol.

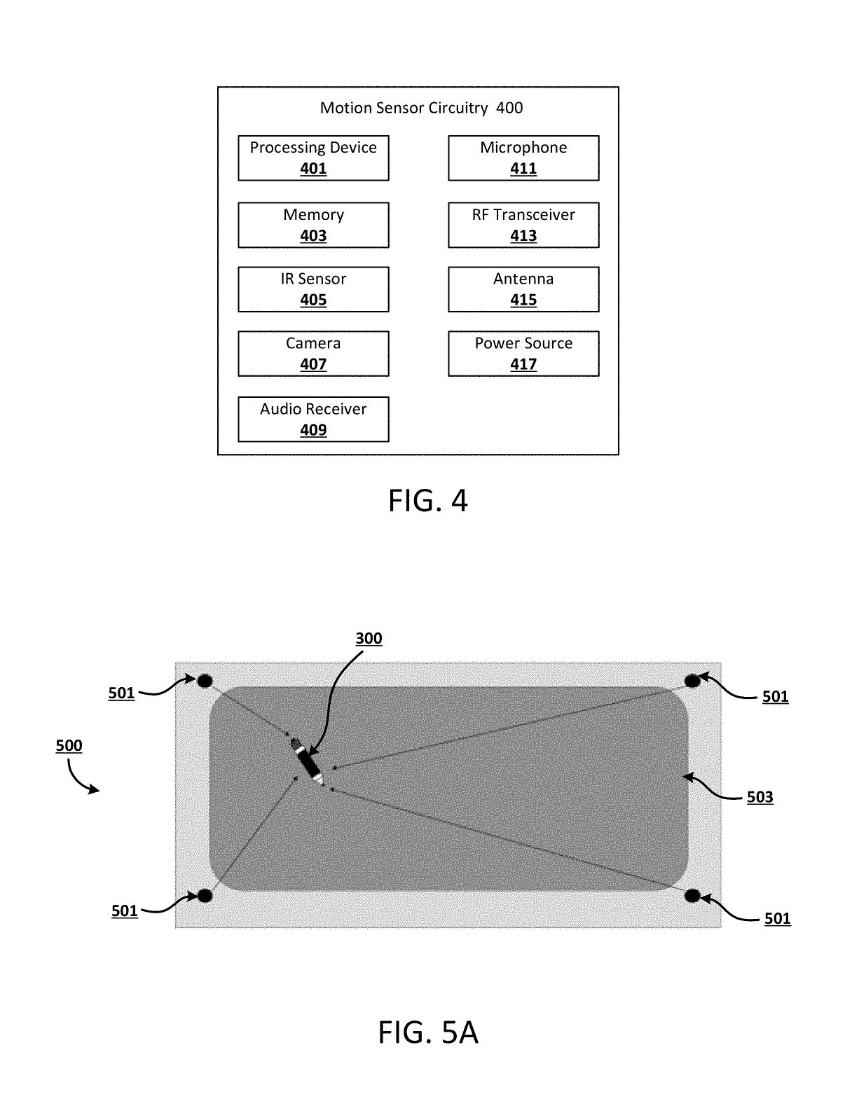

FIG. 4 is a block diagram of motion sensor circuitry 400, according to an exemplary embodiment. The motion sensor circuitry 400 can include, for example, a processing device 401, memory 403 (e.g., RAM), infrared (IR) sensor 405, camera 407, audio receiver 409, microphone 411, RF transceiver 413, antenna 415, and a power source 417. In exemplary embodiments, the IR sensor 405 and/or the camera 407 can be in the direction of the electronic stylus 300 and can calculate a distance between the motion sensor and the electronic stylus 300. The motion sensor circuitry 400 can receive one or more output signals (e.g., X, Y, Z data) from the IR sensor 405 or the camera 407 and can process the signals to determine a location of the electronic stylus with respect to the motion sensor, in some embodiments.

The RF transceiver 413 can be configured to transmit (e.g., via a transmitter of the RF transceiver) and/or receive (e.g., via a receiver of the RF transceiver) wireless transmissions via an antenna 415. For example, the RF transceiver 413 can be configured to transmit one or more messages, directly or indirectly, to the electronic stylus 300 or another motion sensor, and/or to receive one or more messages, directly or indirectly, from electronic stylus 300 or another motion sensor. The RF transceiver 413 can be configured to transmit and/or receive messages having a specified frequency and/or according to a specified sequence and/or packet arrangement. As one example, the RF transceiver 413 can be a BlueTooth® transceiver configured to conform to a BlueTooth® wireless standard for transmitting and/or receiving short-wavelength radio transmissions typically in the frequency range of approximately 2.4 gigahertz (GHz) to approximately 2.48 GHz. As another example, the RF transceiver 413 can be a Wi-Fi transceiver (e.g., as defined IEEE 802.11 standards), which may operate in an identical or similar frequency range as BlueTooth®, but with higher power transmissions. Some other types of RF transceivers 413 that can be implemented by the sensor module circuitry include RF transceivers configured to transmit and/or receive transmissions according to the Zigbee® communication protocol, and/or any other suitable communication protocol. The memory 403 can include any suitable non-transitory computer-readable storage medium (e.g., random access memory (RAM), such as, e.g., static RAM (SRAM), dynamic RAM (DRAM), and the like).

In exemplary embodiments, the processing device 401 can be programmed to receive and process information/data from the IR sensor 405 and/or the camera 407 (e.g. X, Y, Z data), RF transceiver audio receiver 409, microphone 411, memory 403, and/or can be programmed to output information/data to the RF transceiver 413, and/or the memory 403. As one example, the processing device 401 can receive information/data from the IR sensor 405 and/or the camera 407 corresponding to a location of the electronic stylus 300, and can transmit the information/data to a computing system via the RF transceiver 413.

The power source 417 can be implemented as a battery or capacitive elements configured to store an electric charge. In some embodiments, the battery may be replaceable by the user. As another example, in some embodiments, the power source 417 can be a rechargeable power source, such as a battery or one or more capacitive elements configured to be recharged via a connection to an external power supply and/or to be recharged by an energy harvesting device. As one example, the rechargeable power source can be recharged using solar energy (e.g., by incorporating photovoltaic or solar cells on the housing on the sensor module), through physical movement (e.g., by incorporating a piezo-electric elements in the sensor module), and/or through any other suitable energy harvesting techniques using any suitable energy harvesting devices.

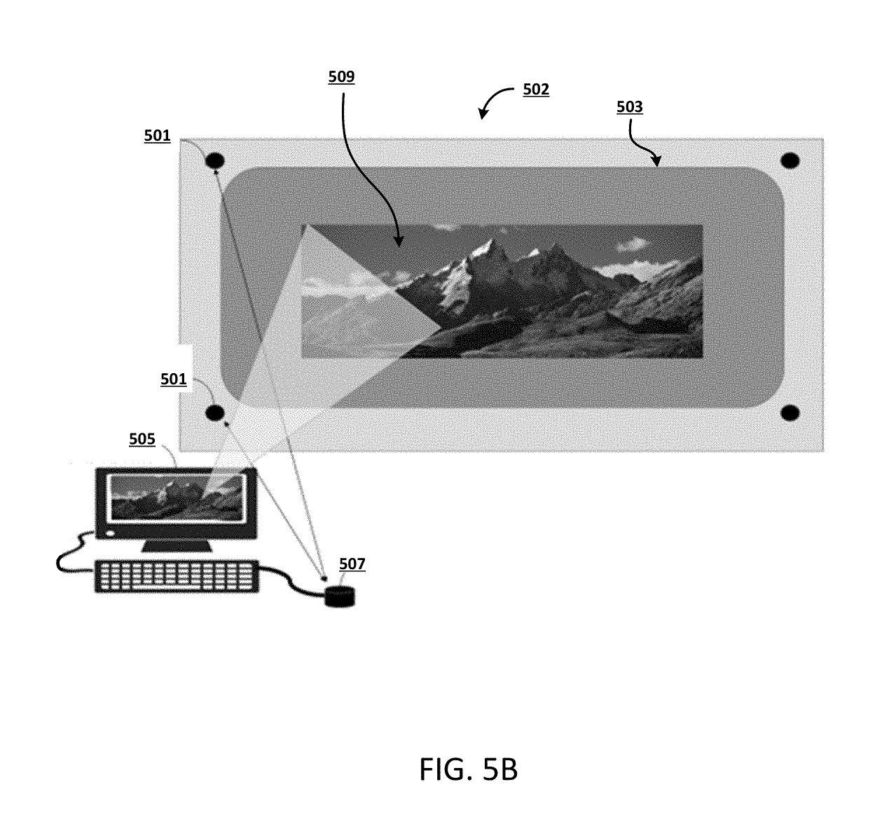

FIG. 5A illustrates an example virtual whiteboard 500, according to an exemplary embodiment. In this particular embodiment, the electronic stylus 300 is in communication with four motion sensors 501 which are configured to scan a planar surface 503 to define an area of for the virtual whiteboard 500. A stylus location sensor included within the electronic stylus 300 estimates the location of the electronic stylus on the planar surface with respect to the motion sensors and generates location data that is transmitted to a computing system, as discussed above. As discussed above, a stylus location sensor can include, for example, an RF transceiver that can calculate a location based on power of signals received from the motion sensors 501.

FIG. 5B illustrates another example virtual whiteboard 502 with a projected image 509, according to an exemplary embodiment. In this example embodiment, an image 509 can be projected from a computing system 505 onto the planar surface 503 scanned by the motion sensors 501. The computing system 505 may include a location sensor 507 that is in communication with the motion sensors 501 in order to ensure that the image 509 is projected to the desired location within the planar surface 503. In some embodiments, a user of the virtual whiteboard 502 may project images, videos, text, etc. onto the planar surface 503 from a smartphone or mobile electronic device. As discussed above, the computing system 505 may project a graphical user interface onto the planar surface 503, in some embodiments.

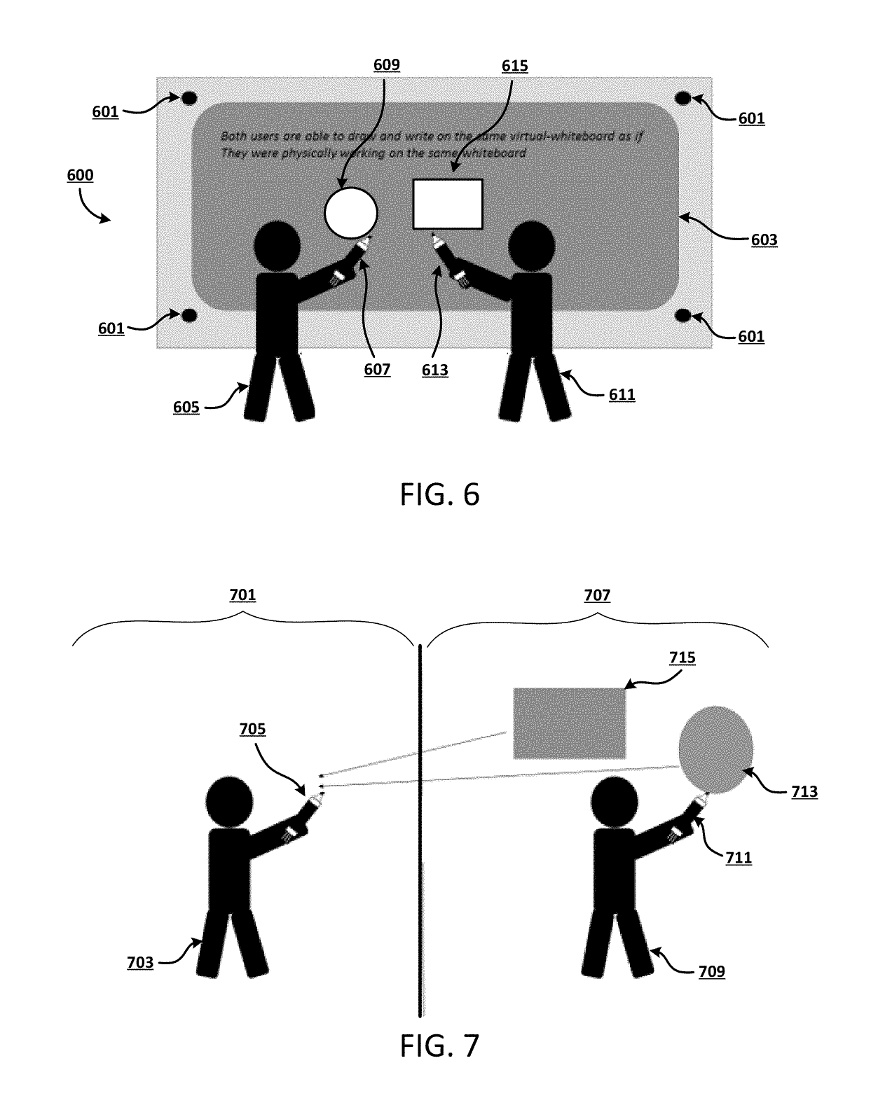

FIG. 6 illustrates another example virtual whiteboard 600, according to an exemplary embodiment. In this example embodiment, a number of motion sensors 601 scan a planar surface 603, and a first user 605 interacts with the virtual whiteboard 600 at a first location using a first electronic stylus 607. Using the first electronic stylus 607, the first user 605 draws a circle 609 on the virtual whiteboard 600. Meanwhile, a second user 611 at a second remote location may interact with the virtual whiteboard 600 using a second electronic stylus 613 to draw a rectangle 615. In some embodiments, the first user 605 and the second user 611 can each utilize a virtual reality or augmented reality headset in order to view the edits and writings of the other user, regardless of the fact that they are each at different locations. These features allow individuals to collaborate remotely using a single virtual whiteboard 600. In some embodiments, a computing system associated with the virtual whiteboard 600 can project images or a user interface onto the planar surface 603, record video or still frames of a virtual whiteboard session, save a virtual whiteboard session for later work, share virtual whiteboard data with other individuals or computing systems, control who is allowed to edit a virtual whiteboard, control when a virtual whiteboard can be edited, etc.

As discussed above, the visual representations may need to be modified or adjusted in scale in order to make visual content from multiple input sources, such as multiple electronic styluses, appear properly for each user. For example, the planar surface on which the first user 605 is working may have different dimensions than the planar surface on which the second user 611 is working. In such an example, the computing system may adjust the inputs from each user in order to adjust the scale of each input for the other. The computing system may implement various wireframing techniques in order to adjust the visual output of the virtual whiteboard environment, in some embodiments.

FIG. 7 illustrates a relationship between a virtual whiteboard 707 and a real-world whiteboard 701, according to an exemplary embodiment. In this particular embodiment, a first individual 703 interacts with a real-world surface 701 using a first electronic stylus 705, while a second individual interacts with a virtual whiteboard 707 using a second electronic stylus 711. In the virtual whiteboard 707, each action of the first electronic stylus 705 and the second electronic stylus 711 is recorded to generate the circle 713 and square 715 images within the virtual whiteboard 707. However, in this example embodiment the first user 703 has enabled a purely virtual operating mode, such that images do not show up on the real-world surface 701. This feature may be useful in scenarios where the first user 703 needs to use a wall or desk surface, rather than an actual erasable whiteboard, as the planar surface for interacting with the virtual whiteboard 707.

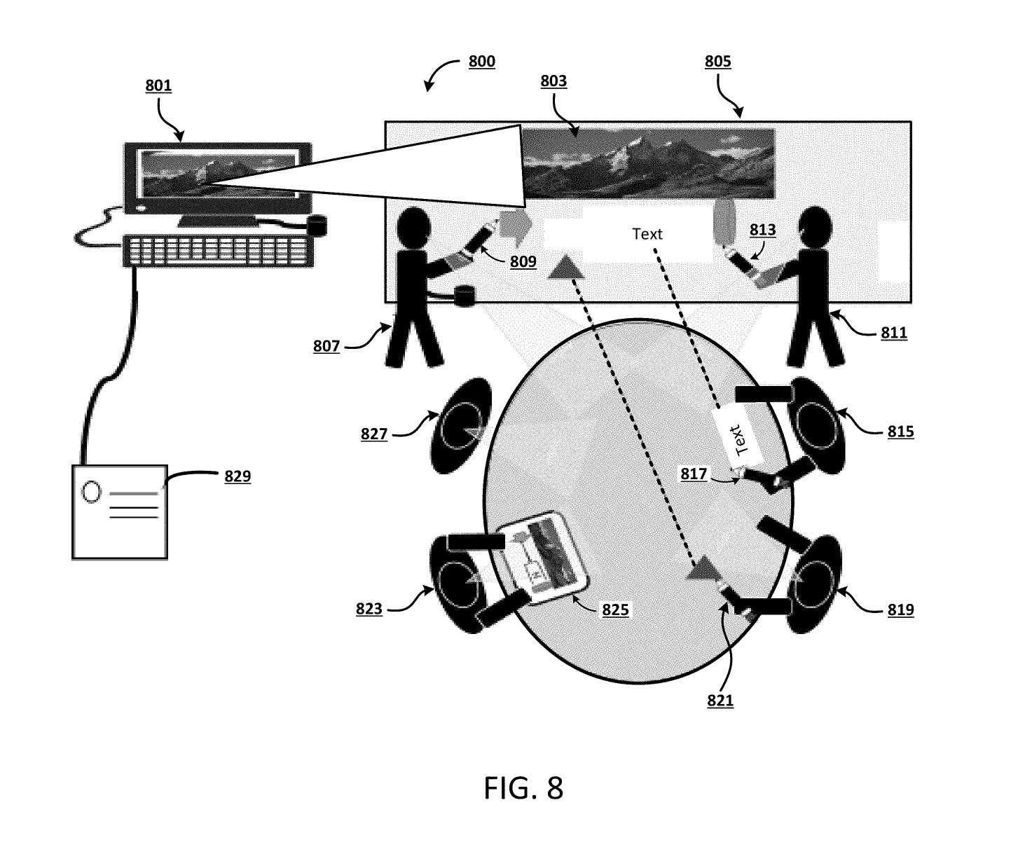

FIG. 8 shows another example virtual whiteboard environment 800, according to an exemplary embodiment. In this example embodiment, a computing system 801 at location A may project an image 803 onto a virtual whiteboard surface 805. A first user 807 at location A may interact with the virtual whiteboard surface 805 of the virtual whiteboard environment 800 using a first electronic stylus 809, while a second user 811 at location B may interact with the virtual whiteboard surface 805 using a second electronic stylus 813. A third user 815 at location C may interact with the virtual whiteboard environment 800 using a third electronic stylus 817 by writing a portion of text on a desk surface, which may appear on the virtual whiteboard surface 805. In this example embodiment, the third electronic stylus 817 is in a purely virtual operating mode such that the text appears on the virtual whiteboard surface 805, but no markings are made on the desk surface at location C. Meanwhile, a fourth user 819 at location D may interact with the virtual whiteboard environment 800 using a fourth electronic stylus 821 by drawing a triangle on the desk surface at location D. Similar to the third electronic stylus 817, the fourth electronic stylus 821 is in a purely virtual operating mode and the triangle is visible on the virtual whiteboard surface 805 but no markings are made on the desk surface at location D. One or more of the first user 807, second user 811, third user 815, or fourth user 819 can view the content of the virtual whiteboard surface 805 using a virtual reality or augmented reality headset, or some other suitable display device. A fifth user 823 at location E may view the content of the virtual whiteboard surface 805, including the projected image 803, the text written by the third user 815, and the triangle drawn by the fourth user 819, using a tablet or other display device 825. In this way, the fifth user 823 may view the virtual whiteboard activity without being fully immersed in a virtual reality or augmented reality environment. In some embodiments, the fifth user 823 may edit or add content to the virtual whiteboard surface 805 using the tablet or display device 825. A sixth user 827 at location F may view the planar surface 805 of the virtual whiteboard environment 800 using, for example, a virtual reality or augmented reality headset, or some other display device. In exemplary embodiments, the audio, video, etc. of the virtual reality whiteboard environment 800 may be recorded and stored on a server 829.

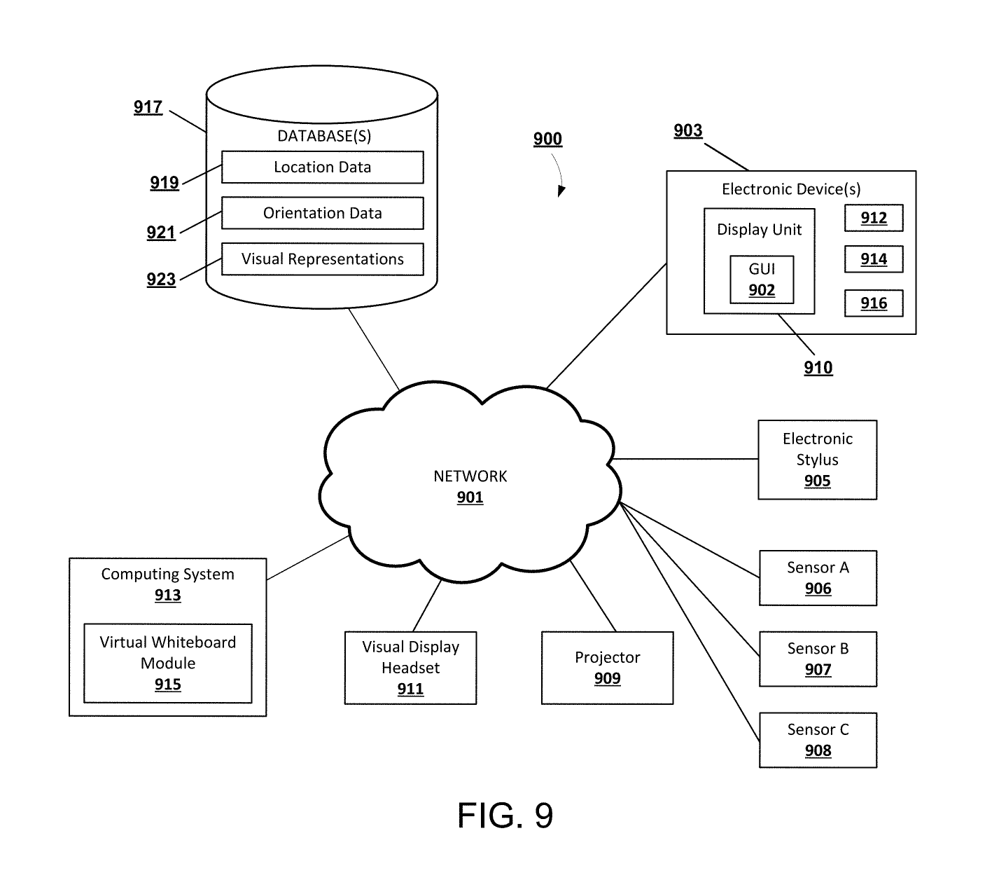

FIG. 9 illustrates a network diagram depicting a system 900 suitable for a distributed implementation of an exemplary embodiment. The system 900 can include a network 901, an electronic device 903, an electronic stylus 905, a number of motion sensors 906-908, a projector 909, a visual display headset 911 (e.g., a virtual reality or augmented reality headset), a computing system 913, and a database 917. In exemplary embodiments, the motion sensors 906-908 are configured to scan a planar surface, and the electronic stylus 905 is configured to communicate with the motion sensors 906-908 and determine the location of the electronic stylus 905 with respect to one or more of the motion sensors 906-908, as discussed above in reference to FIGS. 1-2. As will be appreciated, various distributed or centralized configurations may be implemented without departing from the scope of the present invention. In exemplary embodiments, computing system 913 can store and execute a virtual whiteboard module 915 which can implement one or more of the processes described herein with reference to FIGS. 1-2, or portions thereof. It will be appreciated that the module functionality may be implemented as a greater number of modules than illustrated and that the same server or computing system could also host multiple modules. The database 917 can store the location data 919, orientation data 921, and visual representations 923, as discussed herein. In some embodiments, the virtual whiteboard module 915 can communicate with the electronic stylus 905 to receive location data 919 and orientation data 921. The virtual whiteboard module 915 may also communicate with the electronic device 903, projector 909, and visual display headset 911 to transmit the visual representations 923, as described herein.

In exemplary embodiments, the electronic device 903 may include a display unit 910, which can display a GUI 902 to a user of the electronic device 903. The electronic device can also include a memory 912, processor 914, and a wireless interface 916. In some embodiments, the electronic device 903 may include, but is not limited to, computers, general purpose computers, Internet appliances, hand-held devices, wireless devices, portable devices, wearable computers, cellular or mobile phones, portable digital assistants (PDAs), smart phones, tablets, ultrabooks, netbooks, laptops, multi-processor systems, microprocessor-based or programmable consumer electronics, game consoles, network PCs, mini-computers, smartphones, and the like.

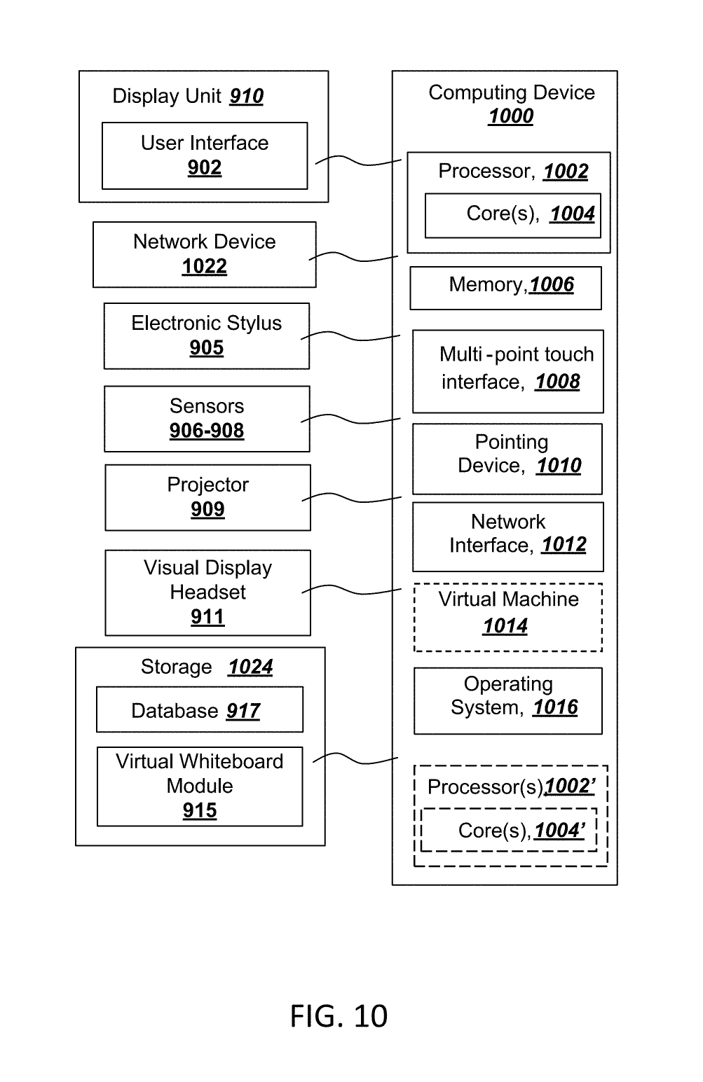

The sensors 906-908, electronic stylus 905, projector 909, visual display headset 911, and the computing system 913 may connect to the network 901 via a wireless connection, and the computing system 913 may include one or more applications such as, but not limited to, a web browser, a geo-location application, and the like. The computing system 913 may include some or all components described in relation to computing device 1000 shown in FIG. 10.

The communication network 901 may include, but is not limited to, the Internet, an intranet, a LAN (Local Area Network), a WAN (Wide Area Network), a MAN (Metropolitan Area Network), a wireless network, an optical network, and the like. In one embodiment, the electronic stylus 905, sensors 906-908, projector 909, visual display headset 911, and the computing system 913, and database 917 may transmit instructions to each other over the communication network 901. In exemplary embodiments, the location data 919, orientation data 921, and visual representations 923 can be stored at the database 917 and received at the computing system 913 in response to a service performed by a database retrieval application.

FIG. 10 is a block diagram of an exemplary computing device 1000 that can be used in the performance of the methods described herein. The computing device 1000 includes one or more non-transitory computer-readable media for storing one or more computer-executable instructions (such as but not limited to software or firmware) for implementing any example method according to the principles described herein. The non-transitory computer-readable media can include, but are not limited to, one or more types of hardware memory, non-transitory tangible media (for example, one or more magnetic storage disks, one or more optical disks, one or more USB flashdrives), and the like.

For example, memory 1006 included in the computing device 1000 can store computer-readable and computer-executable instructions or software for implementing exemplary embodiments and programmed to perform processes described above in reference to FIGS. 1-2. The computing device 1000 also includes processor 1002 and associated core 1004, and optionally, one or more additional processor(s) 1002′ and associated core(s) 1004′ (for example, in the case of computer systems having multiple processors/cores), for executing computer-readable and computer-executable instructions or software stored in the memory 1006 and other programs for controlling system hardware. Processor 1002 and processor(s) 1002′ can each be a single core processor or multiple core (1004 and 1004′) processor.

Virtualization can be employed in the computing device 1000 so that infrastructure and resources in the computing device can be shared dynamically. A virtual machine 1014 can be provided to handle a process running on multiple processors so that the process appears to be using only one computing resource rather than multiple computing resources. Multiple virtual machines can also be used with one processor.

Memory 1006 can be non-transitory computer-readable media including a computer system memory or random access memory, such as DRAM, SRAM, EDO RAM, and the like. Memory 1006 can include other types of memory as well, or combinations thereof.

A user can interact with the computing device 1000 through a display unit 910, such as a touch screen display or computer monitor, which can display one or more user interfaces 902 that can be provided in accordance with exemplary embodiments. The computing device 1000 can also include other I/O devices for receiving input from a user, for example, a keyboard or any suitable multi-point touch interface 1008, a pointing device 1010 (e.g., a mouse or trackpad). The multi-point touch interface 1008 and the pointing device 1010 can be coupled to the display unit 910. The computing device 1000 can include other suitable conventional I/O peripherals.

The computing device 1000 can also include one or more storage devices 1024, such as a hard-drive, CD-ROM, or other non-transitory computer readable media, for storing data and computer-readable instructions and/or software, such as a virtual whiteboard module 915 that can implement exemplary embodiments of the methods and systems as taught herein, or portions thereof. Exemplary storage device 1024 can also store one or more databases 917 for storing any suitable information required to implement exemplary embodiments. The database 917 can be updated by a user or automatically at any suitable time to add, delete, or update one or more items in the databases. Exemplary storage device 1024 can store a database 917 for storing the location data 919, orientation data 921, visual representations 923, and any other data/information used to implement exemplary embodiments of the systems and methods described herein.

The computing device 1000 can also be in communication with an electronic stylus 905, sensors 906-908, a projector 909, and a visual display headset 911, as described above. In exemplary embodiments, the computing device 1000 can include a network interface 1012 configured to interface via one or more network devices 1022 with one or more networks, for example, Local Area Network (LAN), Wide Area Network (WAN) or the Internet through a variety of connections including, but not limited to, standard telephone lines, LAN or WAN links (for example, 802.11, T1, T3, 56 kb, X.25), broadband connections (for example, ISDN, Frame Relay, ATM), wireless connections, controller area network (CAN), or some combination of any or all of the above. The network interface 1012 can include a built-in network adapter, network interface card, PCMCIA network card, card bus network adapter, wireless network adapter, USB network adapter, modem or any other device suitable for interfacing the computing device 1000 to any type of network capable of communication and performing the operations described herein. Moreover, the computing device 1000 can be any computer system, such as a workstation, desktop computer, server, laptop, handheld computer, tablet computer (e.g., the iPad® tablet computer), mobile computing or communication device (e.g., the iPhone® communication device), or other form of computing or telecommunications device that is capable of communication and that has sufficient processor power and memory capacity to perform the operations described herein.

The computing device 1000 can run operating system 1016, such as versions of the Microsoft® Windows® operating systems, different releases of the Unix and Linux operating systems, versions of the MacOS® for Macintosh computers, embedded operating systems, real-time operating systems, open source operating systems, proprietary operating systems, operating systems for mobile computing devices, or other operating systems capable of running on the computing device and performing the operations described herein. In exemplary embodiments, the operating system 1016 can be run in native mode or emulated mode. In an exemplary embodiment, the operating system 1016 can be run on one or more cloud machine instances.

In describing example embodiments, specific terminology is used for the sake of clarity. For purposes of description, each specific term is intended to at least include all technical and functional equivalents that operate in a similar manner to accomplish a similar purpose. Additionally, in some instances where a particular example embodiment includes system elements, device components or method steps, those elements, components or steps can be replaced with a single element, component or step. Likewise, a single element, component or step can be replaced with multiple elements, components or steps that serve the same purpose. Moreover, while example embodiments have been shown and described with references to particular embodiments thereof, those of ordinary skill in the art will understand that various substitutions and alterations in form and detail can be made therein without departing from the scope of the disclosure. Further still, other aspects, functions and advantages are also within the scope of the disclosure.

Example flowcharts are provided herein for illustrative purposes and are non-limiting examples of methods. One of ordinary skill in the art will recognize that example methods can include more or fewer steps than those illustrated in the example flowcharts, and that the steps in the example flowcharts can be performed in a different order than the order shown in the illustrative flowcharts.

What is claimed is:

1. An interactive virtual whiteboard system comprising:
a plurality of motion sensors arranged to scan a planar surface;
an electronic stylus in communication with the plurality of motion sensors over a first communication channel, the electronic stylus including:
a writing tip configured to be controlled by a user to engage the planar surface;
a stylus location sensor configured to estimate a location of the electronic stylus on the planar surface with respect to the plurality of motion sensors and generate location data; and
an inertial sensor configured to detect an orientation or acceleration of the electronic stylus and generate orientation data; and
a computing system in communication with the electronic stylus and the plurality of motion sensors over a second communication channel, the computing system programmed to execute a virtual whiteboard module to:
receive a stream of the location data and the orientation data from the electronic stylus indicating a location and orientation of the electronic stylus with respect to the plurality of motion sensors as a function of time; and
generate a visual representation of a motion of the electronic stylus with respect to the planar surface based on the stream of location data and orientation data received from the electronic stylus.

2. The system of claim 1, further comprising a second electronic stylus in communication with the plurality of motion sensors over the first communication channel, the second electronic stylus including:
a second stylus location sensor configured to estimate a location of the second electronic stylus on the planar surface with respect to the plurality of motion sensors and generate second location data; and
a second inertial sensor configured to detect an orientation or acceleration of the second electronic stylus and generate second orientation data,
wherein the computing system is further configured to receive a second stream of the second location data and the second orientation data from the second electronic stylus as a function of time and generate a second visual representation of a motion of the second electronic stylus with respect to the planar surface based on the second location data and the second orientation data received from the second electronic stylus.

3. The system of claim 1, further comprising a virtual reality headset in communication with the computing system and configured to display the visual representation of the motion of the electronic stylus with respect to the planar surface.

4. The system of claim 1, wherein the computing system includes a projector and is further configured to project images onto the planar surface.

5. The system of claim 4, wherein the electronic stylus is configured to control an operation of the projector.

6. The system of claim 4, wherein the stylus location sensor is further configured to estimate a location of the electronic stylus with respect to a projected graphical user interface projected from the projector.

7. The system of claim 6, wherein the electronic stylus is configured to interact with the projected graphical user interface.

8. A method for generating an interactive virtual whiteboard comprising:
scanning a planar surface using a plurality of motion sensors;
engaging the planar surface using a writing tip of an electronic stylus configured to be controlled by a user;
estimating a location of the electronic stylus on the planar surface with respect to the plurality of motion sensors and generating location data using a stylus location sensor included within the electronic stylus;
detecting an orientation or acceleration of the electronic stylus and generating orientation data using an inertial sensor included within the electronic stylus;
receiving a stream of the location data and the orientation data from the electronic stylus indicating a location and orientation of the electronic stylus with respect to the plurality of motion sensors as a function of time; and
generating a visual representation of a motion of the electronic stylus with respect to the planar surface based on the stream of location data and orientation data received from the electronic stylus.

9. The method of claim 8, further comprising:
estimating a location of a second electronic stylus on the planar surface with respect to the plurality of motion sensors and generating second location data using a second stylus location sensor included within the second electronic stylus;
detecting an orientation or acceleration of the second electronic stylus and generating second orientation data using a second inertial sensor within the second electronic stylus;
receiving a second stream of the second location data and the second orientation data from the second electronic stylus as a function of time; and
generating a second visual representation of a motion of the second electronic stylus with respect to the planar surface based on the second location data and the second orientation data received from the second electronic stylus.

10. The method of claim 8, further comprising:
displaying the visual representation of the motion of the electronic stylus with respect to the planar surface using a virtual reality headset.

11. The method of claim 8, further comprising:
projecting images onto the planar surface using a projector.

12. The method of claim 11, further comprising:
controlling an operation of the projector using the electronic stylus.

13. The method of claim 11, further comprising:
estimating a location of the electronic stylus with respect to a graphical user interface projected from the projector using the stylus location sensor.

14. The method of claim 13, further comprising:
interacting with the projected graphical user interface using the electronic stylus.

15. A non-transitory machine readable medium storing instructions for generating an interactive virtual whiteboard executable by a processing device, wherein execution of the instructions causes the processing device to:
scan a planar surface using a plurality of motion sensors;
estimating a location of an electronic stylus on the planar surface with respect to the plurality of motion sensors and generating location data using a stylus location sensor included within the electronic stylus;
detect an orientation or acceleration of the electronic stylus and generating orientation data using an inertial sensor included within the electronic stylus;
receive a stream of the location data and the orientation data from the electronic stylus indicating a location and orientation of the electronic stylus with respect to the plurality of motion sensors as a function of time; and
generate a visual representation of a motion of the electronic stylus with respect to the planar surface based on the stream of location data and orientation data received from the electronic stylus.

16. The non-transitory machine readable medium of claim 15, wherein execution of the instructions further causes the processing device to:
estimate a location of a second electronic stylus on the planar surface with respect to the plurality of motion sensors and generating location data using a second stylus location sensor included within the second electronic stylus;
detect an orientation or acceleration of the second electronic stylus and generating second orientation data using a second inertial sensor within the second electronic stylus;
receive a second stream of the second location data and the second orientation data from the second electronic stylus as a function of time; and
generate a second visual representation of a motion of the second electronic stylus with respect to the planar surface based on the second location data and the second orientation data received from the second electronic stylus.

17. The non-transitory machine readable medium of claim 15, wherein execution of the instructions further causes the processing device to:
display the visual representation of the motion of the electronic stylus with respect to the planar surface using a virtual reality headset.

18. The non-transitory machine readable medium of claim 15, wherein execution of the instructions further causes the processing device to:
project images onto the planar surface using a projector.

19. The non-transitory machine readable medium of claim 18, wherein execution of the instructions further causes the processing device to:
estimate a location of the electronic stylus with respect to a graphical user interface projected from the projector using the stylus location sensor.

20. The non-transitory machine readable medium of claim 19, wherein execution of the instructions further causes the processing device to:
interact with the projected graphical user interface using the electronic stylus.
